(19) United States
(12) Patent Application Publication
(10) Pub. No.: US 2014/0301170 A1
(43) Pub. Date: Oct. 9, 2014

(54) DISPLAY MECHANISM FOR DISPLAYING A LARGE DATE

(71) Applicant: PEQUIGNET S.A, Morteau (FR)

(72) Inventors: Huy Van Tran, La Chaux-de-Fonds (CH); Ludovic Perez, Villers-le-Lac (FR)

(73) Assignee: PEQUIGNET S.A, Morteau (FR)

(21) Appl. No.: 14/034,116

(22) Filed: Sep. 23, 2013

Related U.S. Application Data
(63) Continuation of application No. PCT/EP2012/055269, filed on Mar. 23, 2012.

(30) Foreign Application Priority Data
Mar. 23, 2011 (FR) 1152404

(51) Int. Cl. G04B 19/253

(52) U.S. Cl. CPC G04B 19/25333
USPC 368/37

(57) ABSTRACT

A display mechanism is disclosed for displaying the day and date in large date form, for a timepiece movement. The display mechanism may include first and second concentric disks, respectively for displaying the tens of the date and for displaying the units of the date. The first disk may have a diameter greater than that of the second disk. The first and second disks may be respectively attached to first and second star wheels each having a toothing. The display mechanism may also include a programmed wheel arranged to drive the first and second star wheels in rotation. The programmed wheel may include first and second outer toothings arranged to cooperate respectively, at least indirectly, with the first and second star wheels. The first toothing may have a diameter less than that of the second toothing.

This application is a continuation application of prior International Application No. PCT/EP2012/055269, filed Mar. 23, 2012 and claiming priority to French (FR) Patent Application No. 1152404, filed Mar. 23, 2011. The disclosures of the above-referenced applications are expressly incorporated herein by reference to their entireties.

### TECHNICAL FIELD

The present disclosure relates to the field of timepieces. More particularly, and without limitation, the present disclosure relates to a display mechanism for displaying the day and date in large date form, for a timepiece movement. The display mechanism may include first and second concentric disks, respectively for displaying the tens of the date and for displaying the units of the date. The first and second disks may be respectively attached to first and second star wheels each having a toothing. The mechanism may also comprise a programmed wheel arranged to drive the first and second star wheels in rotation.

### BACKGROUND

Display mechanisms for timepieces have been disclosed. As an example, the patent application WO 01/77756 A1, filed in the name of Glashütter Uhrenbetrieb GmbH, describes a display mechanism comprising first and second disks, respectively for indicating the tens of the date and the units of the date. These two disks are concentric, the first disk, for the tens, having a diameter smaller than that of the second disk for the units and being arranged inside the second disk for the units. Each of the first and second disks is attached to a star wheel configured to be driven by a programmed wheel.

One main technical difficulty in known display mechanisms for displaying a large date lies in the fact that each step of the programmed wheel has to be associated with a step of the disk of the units of the date and with a step of the disk of the tens of the date.

In the case of the mechanism described in WO 01/77756 A1, the tens disk has to perform a quarter turn each time it is driven, so its star wheel comprises four teeth. By comparison, the disk for indicating the units has to rotate by a tenth of a turn each time it is driven and comprises ten teeth. Thus, for the programmed wheel to be able to simultaneously control the rotation by a quarter turn of the tens disk and by a tenth of a turn for the units disk, it comprises teeth associated with the tens star wheel, the radius of which is notably greater than that of the teeth associated with the units star wheel.

The Octa Réserve de Marche part marketed by the société des Montres Journe à Genève (whose introductory film can be seen at: http://www.youtube.com/watch?v=_Fp-jDqQS70&feature=related) presents a mechanism for displaying the day and date, in large date form, similar to that described above. This mechanism does, however, differ from the preceding one, in that the first disk, for the tens, has a diameter greater than that of the second disk for the units, and is situated outside the latter. To address the problem stated above concerning the differences of step between the two disks, this mechanism provides for the tens disk to bear three series of numerals 0 to 3 for the tens of the date. Thus, the step of the tens disk is a twelfth of a rotation, whereas that of the units disk is still a tenth of a rotation. A programmed crown ring is associated with the star wheel to drive them. The crown ring has inner teeth arranged to drive the units star wheel and includes four studs to drive the tens star wheel, the tens star wheel consequently having teeth with a radius greater than that of the units star wheel.

However, these mechanisms exhibit a common drawback, in terms of energy consumption. In practice, the disk for the units of the date is driven once a day whereas the disk for the tens of the date is driven once every ten days approximately. Each jump of each disk requires an energy input in order to overcome the force of a jumper ensuring the positioning of the corresponding star wheel.

Thus, once every ten days approximately, the two disks have to be driven simultaneously, which means that the programmed wheel that drive them has to have sufficient torque for this purpose. Furthermore, upon the transition from the 31st of a month to the first of the next month, only the tens disk has to be driven in certain mechanisms. Now, the driving of the programmed wheel is not differentiated according to whether it has to drive only the units disk or both at the same time.

Also, when it is driven once a day, the programmed wheel has to have sufficient torque to be able to drive both disks simultaneously, and do so even on days when only the units disk has to be driven. The result is a dissipation or loss of mechanical energy in this mechanism nine days out of ten.

### SUMMARY

The present disclosure includes embodiments that improve on known techniques and overcomes the drawback of known mechanisms for displaying a large date for a timepiece, by proposing such a mechanism that makes it possible to minimize the mechanical energy losses noted above while offering an attractive visual result.

The present disclosure relates more particularly to embodiments that provide a display mechanism as described above, wherein the programmed wheel includes first and second outer toothings arranged to cooperate respectively, at least indirectly, with the first and second star wheels, the first outer toothing having a diameter smaller than that of the second outer toothing.

Advantageously, the toothing of the first star wheel may have a diameter greater than that of the second star wheel.

By virtue of these features, the display mechanism according to the present disclosure requires a lesser energy input than the mechanism known in the prior art. In practice, the smaller radius for the teeth for the tens compared to that of the teeth for the units, on the programmed wheel, means a lesser energy consumption to ensure the driving of the tens disk than to ensure that of the units disk. Consequently, the sum of the total mechanical energy necessary to guarantee the simultaneous driving of both disks is lower than that in the case of the mechanisms of the prior art and, the quantity of mechanical energy unnecessarily dissipated nine days out of ten is reduced.

According to one embodiment, the display mechanism may comprise a hub at least indirectly bearing the second disk and being attached in rotation to the second star wheel. Furthermore, an annular groove may advantageously be formed on the outer periphery of the hub to define a support for the first star wheel.

It is also possible to provide for the first disk to have a first central portion attached to the first star wheel, and a second peripheral annular portion situated in a plane different from that of the central portion, so as to define a central housing with a diameter substantially greater than that of the second disk for the latter to be arranged in the plane of the peripheral annular portion.

By virtue of these features, the two numerals that form the indication of the date appear at the same level, in a window suited to the corresponding timepiece, contributing to the enhancement of the perceived quality thereof.

In one embodiment, the second star wheel may include a bush on which the hub is fitted. Furthermore, a screw may be provided, the latter being configured to be fitted in the bush and in a frame element of the timepiece movement to mount the first and second disks in rotation therein. A tube with seating(s) may also be interposed between the bush and the screw.

Moreover, the present disclosure also relates to a timepiece movement comprising a display mechanism that meets the features mentioned above, as well as a timepiece comprising such a timepiece movement.

### BRIEF DESCRIPTION OF THE DRAWINGS

Other features and advantages of the present disclosure will become more clearly apparent on reading the following detailed description, given with reference to the appended drawings, which are provided by way of non-limiting examples, and in which:

FIG. 1 shows a simplified front view of a part of a timepiece movement according to an embodiment of the present disclosure; and

FIG. 2 shows a simplified transversal cross-sectional view along the cutting line II-II of FIG. 1.

### DETAILED DESCRIPTION OF EMBODIMENTS

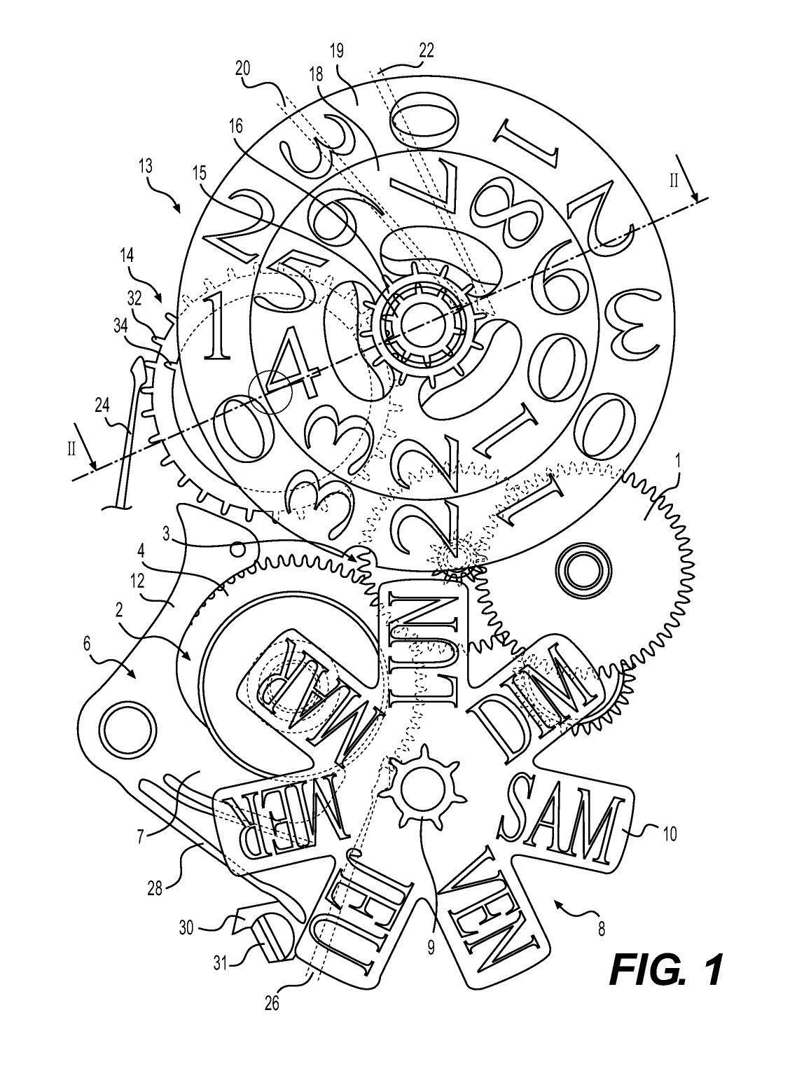

FIG. 1 shows a simplified front view of an instantaneous driving mechanism for a timepiece movement, according to an embodiment of the present disclosure. More specifically, the exemplary driving mechanism shown is configured to control the display of the date in large date form, as well as the day of the week.

The mechanism may comprise a watch-work gear train, linking a time base to a motor member which may be both conventional (not shown), and driving an hour wheel 1 in rotation at a rate of one complete rotation every twelve hours, as a non-limiting indication.

The hour wheel 1 may be kinematically linked to a mobile 2 of the driving mechanism via a set of gears 3, which may be arranged to be engaged with a first toothed wheel 4 of the mobile 2, in such a way that the first toothed wheel 4 performs one complete revolution on itself in 24 hours.

The mobile 2 may cooperate with a lever 6, the operation of which will not be described in detail here, for incrementing, instantaneously and substantially simultaneously, the counters for the date and for the day of the week every 24 hours.

The lever 6 may comprise a first arm 7 configured to increment a first counter of the days of the week 8 by transmitting impulses to a pinion 9, which may include, e.g., 7 teeth, and which may be attached to a disk 10 for displaying the days of the week.

The lever 6 may also comprise a second arm 12 configured to increment a second date counter 13 by transmitting impulses to a programmed wheel 14, which may be referred as a two-stage control wheel, configured to control the displacements of two pinions or star wheels 15 and 16, respectively with 10 and 12 teeth and attached to disks for the units and the tens of the date 18 and 19, to produce a display of large date type.

Jumper springs 20, 22, 24, and 26 may be provided, as is known, to ensure a correct angular positioning of the disks and of the control wheel.

It will also be noted that a spring 28 may be formed integrally with the lever 6 to ensure its correct cooperation with the mobile 2. The spring 28 may be arranged bearing against a cam 30, held on a frame element of the timepiece movement by means of a screw 31. The periphery of the cam 30 may include a succession of segments more or less distant from the center of the cam 30. The prestress that is exhibited by the spring 28 may thus be adjusted according to the segment against which it bears.

Notably, the disk for indicating the tens of the date 19 may include a diameter greater than that of the disk for indicating the units of the date 18 and may be arranged outside the latter. Furthermore, the tens star wheel 16 also may include a diameter greater than that of the units star wheel 15.

Thus, the programmed wheel 14, adjacent to the star wheels 15 and 16, has teeth 32 and 34, respectively for the units and the tens, of suitable dimensions and respectively having 30 and 4 teeth. More specifically, the teeth for the units 32 have a diameter greater than that of the teeth for the tens 34.

By virtue of this feature, the total moment of forces that the programmed wheel 14 has to exhibit to ensure the simultaneous driving of the two disks 18 and 19 is less than it would have to be if its teeth 34 for the tens has a diameter greater than that of its teeth 32 for the units, as is the case with the conventional mechanisms.

Consequently, the display mechanism according to the present disclosure offers an advantage over the conventional mechanisms, in terms of energy consumption, as is stated above.

In the exemplary embodiment illustrated as a non-limiting example, it will be noted that the units disk 18 bears a single series of numerals between 0 and 9, whereas the tens disk 19 bears three times the series of numerals between 0 and 3. Due to a suitable choice of the dimensions of the teeth 32, 34, of the star wheels 15, 16 and of the disks 18, 19, as well as a suitable conformation of the different jumpers involved in the operation of the mechanism, a step of a tenth of a revolution of the units disk 18 corresponds to a step of a twelfth of a revolution of the tens disk 19 in operation.

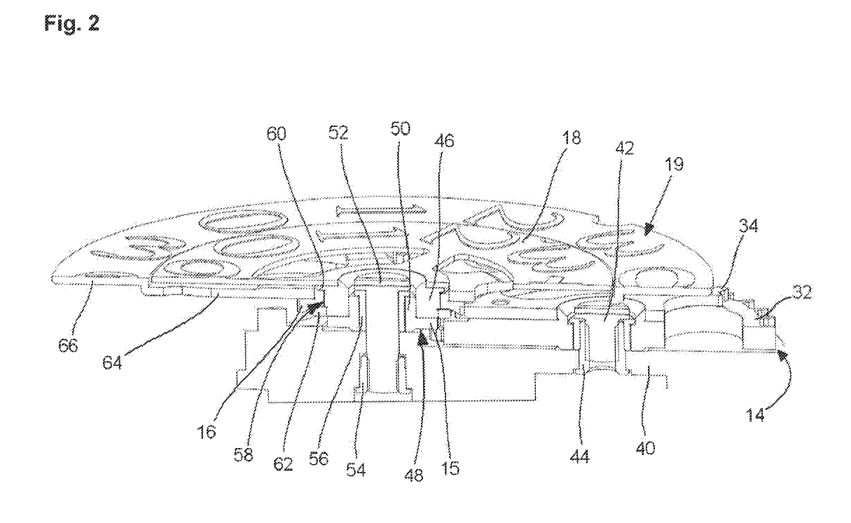

FIG. 2 shows a simplified transversal cross-sectional view along the cutting line II-II of FIG. 1, which provides an appreciation of certain construction details of the exemplary display mechanism, according to an embodiment of the present disclosure.

The programmed wheel 14 may comprise two blocks riveted to one another, as a non-limiting example, to define the two sets of teeth 32 and 34 for the units and for the tens.

The wheel 14 may be attached to the frame of the timepiece movement, herein a plate 40, via a screw 42 cooperating with a screw foot 44 housed in a suitable hole in the plate 40.

The inner units disk 18 may be attached to, for example, driven onto, a central hub 46, which may be in turn attached to a mobile 48 formed by the star wheel 15 and a bush 50 extending from the star wheel to define a support for the central hub.

The mobile 48 may rest on its base on the plate 40 while being retained axially thereon by means of a screw 52 cooperating with a screw foot 54 housed in a suitable additional hole in the plate. A tube with seatings 56 may be interposed between the bush 50 and the screw 52 to ensure the free rotation of the mobile 48 around the latter.

Prior to the assembly of the hub 46 on the timepiece movement, the tens disk 19 may be fitted thereon. In practice, the hub 46 may include a cylindrical guiding surface 58 on its outer periphery, delimited by a shoulder 60 and, suitable for receiving the tens star wheel 16 so that the latter is free in rotation relative to the hub 46. A locking ring 62 may then be driven onto the hub 46 to retain the tens star wheel 19 facing the guiding surface 58 by defining an annular groove.

The disk for the tens of the date 19 may be attached to, for example, by being driven onto, the tens star wheel 16. The latter has a first central portion 64 that may be substantially flat and with a maximum radius slightly greater than the radius of the units disk 18. The central portion 64 may be followed by a peripheral annular portion 66 situated in a plane different from that of the central portion. More specifically, once the assembly described above is assembled, the peripheral annular portion 66 may be located substantially in the same plane as the units disk 18.

When this assembly is assembled, it is put in place on the plate, in the manner described previously.

This assembly method advantageously makes it possible to render the dimensions of the star wheels 15 and 16 independent relative to the relative positioning of the disks 18 and 19 for the units and for the tens of the date.

Thus, it is possible to implement a star wheel 19 with a diameter greater than those used in relation to the prior art mechanisms, to limit the energy dissipation exhibited above and which occurs approximately nine days out of ten upon the change of date.

The above description provides non-limiting illustrations, and the disclosure is not limited to the implementation of certain particular characteristics described above, such as, for example, the structure of the driving mechanism or the forms represented for its various component parts.

In particular, it will be noted that the method for fastening the assembly consisting of the disks and their assembled star wheels, as described, is non-limiting and may be performed differently, such as, for example, by arranging the assembly on a ball race or dual holes, even on a post.

A person skilled in the art will not have any particular difficulty in adapting the content of the present disclosure to his or her own needs and implementing a display mechanism of large date type comprising a programmed wheel comprising a toothing for driving a disk for the tens of the date of a diameter that is smaller than the toothing for driving a disk for the units of the date, to limit the mechanical energy dissipation, without departing from the framework of the present disclosure.

What is claimed is:

1. A display mechanism for displaying the day and date in large date form, for a timepiece movement, the display mechanism comprising:
first and second concentric disks, respectively for displaying the tens of the date and for displaying the units of the date, said first disk having a diameter greater than that of said second disk, said first and second disks being respectively attached to first and second star wheels each having a toothing; and
a programmed wheel arranged to drive said first and second star wheels in rotation, said programmed wheel including first and second outer toothings arranged to cooperate respectively, at least indirectly, with said first and second star wheels, said first outer toothing having a diameter smaller than that of said second outer toothing.

2. The display mechanism of claim 1, wherein said toothing of said first star wheel has a diameter greater than that of said second star wheel.

3. The display mechanism of claim 1, further comprising a hub at least indirectly bearing said second disk and being attached in rotation to said second star wheel, wherein an annular groove is formed on an outer periphery of said hub to define a guiding surface for said first star wheel.

4. The display mechanism of claim 1, wherein said first disk has a first central portion attached to said first star wheel, and a second peripheral annular portion situated in a plane different from that of said central portion, so as to define a central housing with a diameter substantially greater than that of said second disk for said second disk to be arranged in the plane of said peripheral annular portion.

5. The display mechanism of claim 3, wherein said second star wheel includes a bush on which said hub is fitted.

6. The display mechanism of claim 5, further comprising a screw configured to be fitted in said bush and in a frame element of a timepiece movement in order to mount said first and second disks in rotation therein.

7. The display mechanism of claim 6, wherein a tube with seating is interposed between said bush and said screw.

8. A timepiece movement comprising a mechanism for displaying the day and date in large date form, the mechanism comprising:
first and second concentric disks, respectively for displaying the tens of the date and for displaying the units of the date, said first disk having a diameter greater than that of said second disk, said first and second disks being respectively attached to first and second star wheels each having a toothing; and
a programmed wheel arranged to drive said first and second star wheels in rotation, said programmed wheel including first and second outer toothings arranged to cooperate respectively, at least indirectly, with said first and second star wheels, said first outer toothing having a diameter smaller than that of said second outer toothing.

9. A timepiece movement comprising a frame element and a display mechanism for displaying the day and date in large date form, the display mechanism comprising:
first and second concentric disks, respectively for displaying the tens of the date and for displaying the units of the date, said first disk having a diameter greater than that of said second disk, said first and second disks being respectively attached to first and second star wheels each having a toothing;
a programmed wheel arranged to drive said first and second star wheels in rotation, said programmed wheel including first and second outer toothings arranged to cooperate respectively, at least indirectly, with said first and second star wheels, said first toothing having a diameter smaller than that of said second toothing;
a hub at least indirectly bearing said second disk and being attached in rotation to said second star wheel, wherein an annular groove is formed on an outer periphery of said hub to define a guiding surface for said first star wheel, said second star wheel including a bush on which said hub is fitted; and
a screw configured to be fitted in said bush and in a frame element of a timepiece movement in order to mount said first and second disks in rotation therein, said screw being fitted in said bush of said second star wheel and being attached to said frame element.

10. A timepiece comprising a timepiece movement including a mechanism for displaying the day and date in large date form, said mechanism comprising:
first and second concentric disks, respectively for displaying the tens of the date and for displaying the units of the date, said first disk having a diameter greater than that of said second disk, said first and second disks being respectively attached to first and second star wheels each having a toothing;
a programmed wheel arranged to drive said first and second star wheels in rotation, said programmed wheel including first and second outer toothings arranged to cooperate respectively, at least indirectly, with said first and second star wheels, said first outer toothing having a diameter smaller than that of said second outer toothing.

11. The display mechanism of claim 2, further comprising a hub at least indirectly bearing said second disk and being attached in rotation to said second star wheel, wherein an annular groove is formed on an outer periphery of said hub to define a guiding surface for said first star wheel.

12. The display mechanism of claim 2, wherein said first disk has a first central portion attached to said first star wheel, and a second peripheral annular portion situated in a plane different from that of said central portion, so as to define a central housing with a diameter substantially greater than that of said second disk for said second disk to be arranged in the plane of said peripheral annular portion.

13. The display mechanism of claim 3, wherein said first disk has a first central portion attached to said first star wheel, and a second peripheral annular portion situated in a plane different from that of said central portion, so as to define a central housing with a diameter substantially greater than that of said second disk for said second disk to be arranged in the plane of said peripheral annular portion.

14. The display mechanism of claim 4, wherein said second star wheel includes a bush on which said hub is fitted.

15. The display mechanism of claim 13, wherein said second star wheel includes a bush on which said hub is fitted.

16. The display mechanism of claim 14, further comprising a screw configured to be fitted in said bush and in a frame element of a timepiece movement in order to mount said first and second disks in rotation therein.

17. The display mechanism of claim 15, further comprising a screw configured to be fitted in said bush and in a frame element of a timepiece movement in order to mount said first and second disks in rotation therein.

18. The display mechanism of claim 16, wherein a tube with seating is interposed between said bush and said screw.

19. The timepiece movement of claim 8, wherein said toothing of said first star wheel has a diameter greater than that of said second star wheel.

20. The timepiece of claim 10, wherein said toothing of said first star wheel has a diameter greater than that of said second star wheel.
